(19) United States
(12) Patent Application Publication
(10) Pub. No.: US 2020/0153535 A1
(43) Pub. Date: May 14, 2020

(54) REINFORCEMENT LEARNING BASED COGNITIVE ANTI-JAMMING COMMUNICATIONS SYSTEM AND METHOD

(71) Applicant: Bluecom Systems and Consulting LLC, Albuquerque, NM (US)

(72) Inventors: Sudharman Jayaweera Kankanamge, Albuquerque, NM (US); Christos Christodoulou, Albuquerque, NM (US)

(21) Appl. No.: 16/186,169

(22) Filed: Nov. 9, 2018

(51) Int. Cl. H04K 3/00; G06N 3/08; G06K 9/62; G06N 3/04; H04B 1/00; G06F 7/58

(52) U.S. Cl. CPC H04K 3/22; G06N 3/08; G06F 7/588; G06N 3/04; H04B 1/0003; G06K 9/6267

(57) ABSTRACT

Systems and methods of using machine-learning in a cognitive radio to avoid a jammer are described. Smoothed power spectral density is used to detect activity in a sub-band and basic characteristics of different signals therein extracted. If unable to classify the signals as either a valid signal or a jammer using the basic characteristics, ANN-based classification with cumulants features of the signals is used. Multiple periods are used to train sensing and communications (S/C) polices to track and avoid a jammer using RL (e.g. Q learning). The ANN has input neurons of higher order cumulants of a sensing channel and a single output neuron. The S/C polices are coupled during training and communication using negative or decreasing rewards based on the time the sensing policy takes to determine jammer presence and that the cognitive radio is jammed. A feedback channel provides a new communications channel to a radio transmitting to the cognitive radio.

### STATEMENT REGARDING FEDERALLY SPONSORED RESEARCH OR DEVELOPMENT

This application was made with Government support under contract # NNX17CC01C awarded by the National Aeronautics and Space Administration (NASA). The government has certain rights in this application.

### TECHNICAL FIELD

Aspects pertain to communication jamming and anti jamming. Some embodiments relate to the use of machine learning to discriminate between jamming signals and actual communication signals.

### BACKGROUND

Network use continues to increase due to both an increase in the types of devices using network resources as well as the amount of data and bandwidth being used by various applications on individual devices, such as video streaming, operating on these communication devices. The increase in network use may cause physical layer problems within the network, such as increasing the amount of interference within the system, which may decrease the network effectiveness and perhaps limit communications. In addition to inadvertent interference, however, the interference may be deliberate in certain situations. Such deliberate interference may include jamming used in electronic warfare to, for example, eliminate the electronic tracking capabilities of a vehicle or a Denial-of-Service (DoS) attack to, for example, removes the ability of a handheld device or laptop to access the network. Independent of the jamming circumstances, jamming can be implemented in a continuous or discontinuous manner and in a wideband or narrowband manner. In the former, a jammer may continuously transmit high power signals in the desired frequency range irrespective of whether packets are being transmitted; in the latter (reactive jamming), the jammer senses the use of the spectrum and responds by jamming all or portions of the packets being transmitted.

Reactive jamming uses less energy and is relatively difficult to detect (compared to continuous jamming) due to the length of the jamming signal, which may be significantly shorter than the transmission. It would he desirable to enable a system and method able to discriminate between intentional jamming signals and normal interference caused by other communication devices using the same frequency bands, and permit communications despite the presence of the jamming signals.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1 illustrates a communication device in accordance with some embodiments.

FIG. 2 illustrates a cognitive communications system architecture in accordance with some embodiments.

FIG. 3 illustrates another cognitive communications system architecture in accordance with some embodiments.

FIG. 4 illustrates operation of the other cognitive communications system architecture in accordance with some embodiments.

FIG. 5 illustrates training and use of a machine-learning algorithm in accordance with some embodiments.

FIG. 6 illustrates a jammer discrimination framework in accordance with some embodiments.

FIG. 7 illustrates a first learning period for the sensing policy in accordance with some embodiments.

FIG. 8 illustrates a second learning period for the sensing policy in accordance with some embodiments.

FIG. 9 illustrates a coupled communication policy in accordance with some embodiments.

FIG. 10 illustrates jammer tracking during a communication phase in accordance with some embodiments.

FIG. 11 illustrates communication phase anti-jamming in accordance with some embodiments.

### DETAILED DESCRIPTION

The following description and the drawings sufficiently illustrate specific aspects to enable those skilled in the art to practice them. Other aspects may incorporate structural, logical, electrical, process, and other changes. Portions and features of some embodiments may be included in, or substituted for, those of other aspects. Aspects set forth in the claims encompass all available equivalents of those claims.

As above, it is desired to overcome jamming of a network by detected jammer signals and avoiding the jammer to transmit the communication signals. To this end, a wideband autonomous cognitive radio comprising a software-defined radio (SDR) and a cognitive engine (CE) as described herein may be designed to use at least one channel for spectrum sensing to track the jammer while at least another channel is used to perform actual communication in commercial and/or military communication systems and hands. A cognitive radio may be configured to employ dynamic spectrum management by using one or more channels to avoid interference and congestion by sensing the RF environment to detect the signals present and the available channels, making decisions based on the types of signals present and adjusting communications accordingly based on interference patterns. The controller in the cognitive radio, named the cognitive engine, may alter communication parameters such as the frequency, time and/or modulation type to enable communications in communications channel, which may be a white space unoccupied by signals or gray space only partially occupied by signals.

A first step in the dynamic avoidance may be to discriminate between valid signals/interference from other network devices (e.g., cellphones) from those created by a jammer. The cognitive radio may use a machine-learning trained classifier for such signal identification. The machine-learning trained classifier may be implemented at least in part by an artificial neural network. The machine-learning trained classifier may extract features in real-time from a sub-band signal that may contain multiple signals at unknown frequencies. A multi-stage hierarchical signal classification and identification framework may be used along with a sensing policy in which all signals in the sensing channel may first be detected, and parameters such as the center-frequencies and approximate bandwidths of the signals may subsequently be estimated. After estimation of the signal parameters, a digital down-conversion (DDC) process may be used on each of the signals using digitally-synthesized carriers. Digital low-pass filters (LPF) may then be applied to each of the digital down-converted signals to extract each of the signals in isolation. Finally, the feature vectors of each signal may be extracted and passed on to the classifier.

In some embodiments, the cognitive radio may determine whether the channel on which actual communications are received is being jammed based on one or both error vector magnitude (DIM) or modulation error rate (MER). Both the sensing channel and the communications channel may use reinforcement learning (RL) methods to learn how to track the jammer accurately and how to avoid the jammer effectively. The learning mechanisms may be coupled so that whenever the communications channel is jammed before the sensing policy is able to indicate to the controller to switch from the current communications channel to a different communications channel, both the current sensing and communications policies are penalized. The result of perfect learning is a situation in which the communications channel is always switched to a new channel just before jammer arrives in the current communications channel to jam the current communications channel, thereby depriving the jammer the chance to learn where the communications signal is at any given time. Similarly, under perfect learning, the sensing policy will always exactly follow the jammer (jammer tracking).

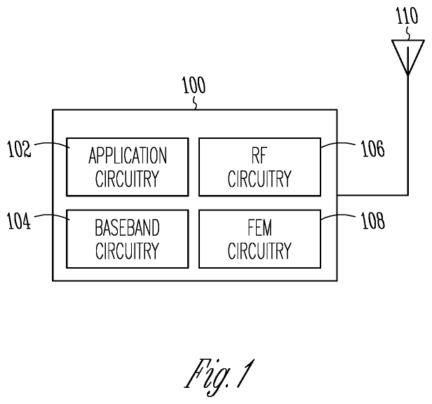

Embodiments described herein may be implemented into a system using any suitably configured hardware and/or software. FIG. 1 illustrates components of a communication device in accordance with some embodiments. The communication device 100 may be one of a stationary, non-mobile device, a mobile device or incorporated into a vehicle, for example. The communication device 100 may include application circuitry 102, baseband circuitry 104. Radio Frequency (RF) circuitry 106, front-end module (FEM) circuitry 108 and one or more antennas 110. At least some of the baseband circuitry 104. RF circuitry 106, and FEM circuitry 108 may form a transceiver. The communication device 100 may be connected with other network elements such as an access point (AP) or base station such as an evolved NodeB (eNB) or next generation NodeB (gNB). The base station may be a macro, micro, pica or nano base station. Alternatively, the cognitive radio could be connected to another radio in a D2D configuration without using a base station as in an ad-hoc network.

The application or processing circuitry 102 may include one or more application processors. For example, the application circuitry 102 may include circuitry such as one or more single-core or multi-core processors. The processor(s) may include any combination of general-purpose processors and dedicated processors (e.g., graphics processors, application processors, etc.). The processors may be coupled with and/or may include memory;/storage and may be configured to execute instructions stored in the memory/storage to enable various applications and/or operating systems to run on the system.

The baseband circuitry 104 may include circuitry such as one or more single-core or multi-core processors. The baseband circuitry 104 may include one or more baseband processors and/or control logic to process baseband signals received from a receive signal path of the RF circuitry 106 and to generate baseband signals for a transmit signal path of the RF circuitry 106. Baseband processing circuitry 104 may interface with the application circuitry 102 for generation and processing of the baseband signals and for controlling operations of the RF circuitry 106. The baseband circuitry 104 may include one or more baseband processors for one or more different technologies, such as different 3GPP generations. The baseband circuitry 104 may handle various radio control functions that enable communication with one or more radio networks via the RF circuitry 106. The radio control functions may include signal modulation/demodulation, encoding/decoding, radio frequency shifting, etc. Modulation/demodulation circuitry of the baseband circuitry 104 may include Fast-Fourier Transform (EFT), preceding, and/or constellation mapping/demapping functionality. Encoding/decoding circuitry of the baseband circuitry 104 may include convolution, tail-biting convolution, turbo, Viterbi, and/or Low Density Parity Check (LDPC) encoder/decoder functionality.

The baseband circuitry 104 may include elements of a protocol stack such as, for example physical (PHY), media access control (MAC), radio link control (RLC), packet data convergence protocol (PDCP), and/or radio resource control (RRC) elements. A central processing unit (CPU) of the baseband circuitry 104 may be configured to run elements of the protocol stack for signaling of the PHY, MAC, RLC, PDCP and/or RRC layers. The baseband circuitry 104 may include one or more audio digital signal processor(s) (DSP). The audio DSP(s) may be include elements for compression/decompression and echo cancellation and may include other suitable processing elements in other embodiments. This is only one embodiment of baseband circuitry. In other embodiments, the technique disclosed herein may be applicable to systems that do not adhere to the above protocol stack structure, such as in mobile ad-hoc and/or mesh networks (MANET). Components of the baseband circuitry may be suitably combined in a single chip, a single chipset, or disposed on a same circuit board in some embodiments. Some or all of the constituent components of the baseband circuitry 104 and the application circuitry 102 may be implemented together such as, for example, on a system on a chip (SOC) in a software-defined radio.

The baseband circuitry 104 may provide for communication compatible with one or more radio technologies. For example, in some embodiments, the baseband circuitry 104 may support communication with an evolved universal terrestrial radio access network (EUTRAN) and/or other wireless metropolitan area networks (WMAN), a wireless local area network (WLAN), or a wireless personal area network (WPAN). Embodiments in which the baseband circuitry 104 is configured to support radio communications of more than one wireless protocol may be referred to as multi-mode baseband circuitry. The communication device 100 can be configured to operate in accordance with communication standards or other protocols or standards, including Institute of Electrical and Electronic Engineers (IEEE) 802.16 wireless technology (WiMax), IEEE 802.11 wireless technology (WiFi) including IEEE 802.ad, which operates in the 60 GHz millimeter wave spectrum, various other wireless technologies such as global system for mobile communications (GSM), enhanced data rates for GSM evolution (EDGE), GSM EDGE radio access network (GERAN), universal mobile telecommunications system (UMTS), UMTS terrestrial radio access network (UTRAN), or other 1G, 3G, 4G, 5G, etc. technologies either already developed or to be developed such as Bluetooth or Zigbee, MANET, among others.

RF circuitry 106 may enable communication with wireless networks using modulated electromagnetic radiation through a non-solid medium. In various embodiments, the RF circuitry 106 may include switches, filters, amplifiers, etc. to facilitate the communication with the wireless network. The RF circuitry 106 may include a receive signal path which may include circuitry to down-convert RF signals received from the FEM circuitry 108 and provide baseband signals to the baseband circuitry 104. The RF circuitry 106 may also include a transmit signal path which may include circuitry to up-convert baseband signals provided by the baseband circuitry 104 and provide RF output signals to the FEM circuitry 108 for transmission. The RF output signals may be frequency-division multiple access (FDMA) and/or time-division multiple-access (TDMA) signals.

The RF circuitry 106 may include at least one receive and transmit signal path. The receive signal path of the RF circuitry 106 may include mixer circuitry, amplifier circuitry and filter circuitry. The transmit signal path of the RF circuitry 106 may include filter circuitry, amplifier circuitry and mixer circuitry. The RF circuitry 106 may also include synthesizer circuitry for synthesizing a frequency for use by the mixer circuitry of the receive signal path and the transmit signal path. The mixer circuitry of the receive signal path may be configured to down-convert RF signals received from the FEM circuitry 108 based on the synthesized frequency provided by synthesizer circuitry. The amplifier circuitry may be configured to amplify the down-converted signals and the filter circuitry may be a low-pass filter (LPF) or band-pass filter (BPF) configured to remove unwanted signals from the down-converted signals to generate output baseband signals. Output baseband signals may be provided to the baseband circuitry 104 for further processing. The mixer circuitry 106a of the receive signal path may comprise passive mixers.

The mixer circuitry 106a of the transmit signal path may be configured to up-convert input baseband signals based on the synthesized frequency provided by the synthesizer circuitry to generate RF output signals for the FEM circuitry 108. The baseband signals may be provided by the baseband circuitry 104 and may be filtered by filter circuitry. The filter circuitry may include a LPF.

The mixer circuitry of the receive signal path and the mixer circuitry of the transmit signal path may include two or more mixers and may be arranged for quadrature down-conversion and/or up-conversion respectively. The mixer circuitry of the receive signal path and the mixer circuitry of the transmit signal path may include two or more mixers and may be arranged for image rejection (e.g., Hartley image rejection). The mixer circuitry of the receive signal path may be arranged for direct down-conversion and/or direct up-conversion, respectively. The mixer circuitry of the receive signal path and the mixer circuitry of the transmit signal path may be configured for super-heterodyne operation.

The output baseband signals and the input baseband signals may be digital baseband signals. The RF circuitry 106 may include analog-to-digital converter (ADC) and digital-to-analog converter (DAC) circuitry and the baseband circuitry 104 may include an interface to communicate with the RF circuitry 106.

In some embodiments, the synthesizer circuitry may be a fractional-N synthesizer or a fractional N/N+1 synthesizer, a delta-sigma synthesizer, a frequency multiplier, or a synthesizer comprising a phase-locked loop with a frequency divider. The synthesizer circuitry may be configured to synthesize an output frequency for use by the mixer circuitry of the RF circuitry 106 based on a frequency input and a divider control input.

In some embodiments, frequency input may be provided by a voltage controlled oscillator (VCO). Divider control input may be provided by either the baseband circuitry 104 or the applications processor 102 depending on the desired output frequency. In some embodiments, a divider control input (e.g., N) may be determined from a look-up table based on a channel indicated by the applications processor 102.

The synthesizer circuitry of the RF circuitry 106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a. carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

The synthesizer circuitry may be configured to generate a carrier frequency as the output frequency, or the output frequency may be a multiple of the carrier frequency (e.g., 2× or 4× the carrier frequency) and used in conjunction with quadrature generator and divider circuitry to generate multiple signals at the carrier frequency with multiple different phases with respect to each other. The output frequency may be a LO frequency (f_{LO}). In some embodiments, the RF circuitry 106 may include an IQ/polar converter.

The FEM circuitry 108 may include a receive signal path which may include circuitry configured to operate on RF signals received from one or more antennas 110, amplify the received signals and provide the amplified versions of the received signals to the RF circuitry 106 for further processing. FEM circuitry 108 may also include a transmit signal path which may include circuitry configured to amplify signals for transmission provided by the RF circuitry 106 for transmission by one or more of the one or more antennas 110.

The FEM circuitry 108 may include a transmission/reception (TX/RX) switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 106). The transmit signal path of the FEM circuitry 108 may include a power amplifier (PA) to amplify input RF signals (e.g., provided by RF circuitry 106), and one or more filters to generate RF signals for subsequent transmission (e.g., by one or more of the one or more antennas 110).

The communication device 100 may include additional elements such as, for example, memory/storage, display, camera, sensor, and/or input/output (I/O) interface as described in more detail below. The communication device 100 described herein may be part of a portable wireless communication device, such as a laptop or portable computer with wireless communication capability, a web tablet, a wireless telephone, a smartphone, a wireless headset, an instant messaging device, a digital camera, an access point, a television, a medical device (e.g., a heart rate monitor, a blood pressure monitor, etc.), or other device that may receive and/or transmit information wirelessly and that may be standalone or installed in a vehicle (for example airplanes used in electronic warfare systems, drones, satellite or worn by a human (wearable radios)). The communication device 100 may include one or more user interfaces designed to enable user interaction with the system and/or peripheral component interfaces designed to enable peripheral component interaction with the system. For example, the communication device 100 may include one or more of a keyboard, a keypad, a touchpad, a display, a sensor, a non-volatile memory port, a universal serial bus (USB) port, an audio jack, a power supply interface, one or more antennas, a graphics processor, an application processor, a speaker, a microphone, and other I/O components. The display may be an LCD or LED screen including a touch screen. The positioning unit may communicate with components of a positioning network, e.g., a global positioning system (GPS) satellite.

The antennas 110 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 110 may be effectively separated to take advantage of spatial diversity and the different channel characteristics that may result. The antennas can be reconfigurable in real-time to allow for rapid spectrum agility, for either intra-band or inter-band shifts when communications in a particular channel (or band) are jammed by the jammer.

Although the communication device 100 is illustrated as having several separate functional elements, one or more of the functional elements may be combined and may be implemented by combinations of software-configured elements, such as processing elements including DSPs, and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. The machine readable medium stores one or more sets of data structures or instructions (e.g., software) embodying or utilized by any one or more of the techniques or functions described herein.

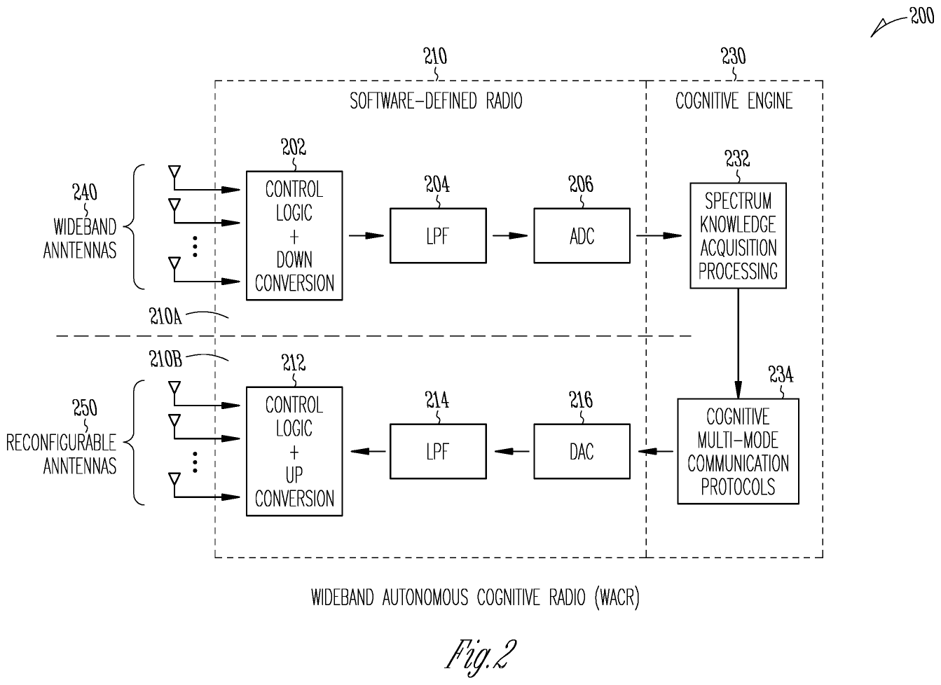

As above, the communication device shown in FIG. 1 may include a cognitive radio. FIG. 2 illustrates a cognitive communications system architecture in accordance with some embodiments. The wideband autonomous cognitive radio (WACR) 200 shown may contain other components, which are not shown for convenience. The components of the WACR 200 shown may be partitioned into the software-defined radio 210 and the cognitive engine 230.

The WACR 200 shows a FDMA system architecture, although in other embodiments, the WACR 200 may use a TDMA system architecture or hybrid FDMA/TDMA system architecture thereof. As shown, in the FDMA WACR 200, two separate frequency channels (two separate RF chains) may be used for sensing and communications. The software-defined radio 210 may thus have one RF port that always performs spectrum sensing while the other port is used for actual communications.

The software-defined radio 210 may implement traditional hardware components in software executed by a processor. The software-defined radio 210 may provide a receive path 210a through which signals in the spectrum sensing channel received by the wideband antenna(s) 240 may be processed and supplied to the cognitive engine 230, and a transmit path 210h through which signals from the cognitive engine 230 are supplied to the reconfigurable antenna(s) 250 for transmission in the communications channel. The receive path 210a and transmit path 210b may include functions such as control logic 202, 212, filtering 204, 214 and converters 206, 216. The control logic 202, 212 may provide down conversion of the received RF signals from the wideband antennas 240 directly to baseband (or indirectly through an intermediate frequency) in the receive path 210a and similarly up conversion of the received baseband signals to the reconfigurable antennas 250 directly to RF (or indirectly through an intermediate frequency) in the transmit path 210b as described in relation to FIG. 1. The wideband antennas 240 and reconfigurable antennas 250 may be used respectively for sensing and communications. The filtering 204, 214 may include one or more LPFs. The converters 206, 216 may include an ADC 206 in the receive path 210a and a DAC 216 in the transmit path 210b. The reconfigurable antennas 250 and perhaps the wideband antennas 240 may be configurable to be able to switch inter- or intra-band (e.g., between military and LTE bands or within the military band).

The cognitive engine 230 may have multiple functions, including sensing acquisition 232 which may be responsible for processing the received and converted digital sensing signals to train based on the spectrum use and protocol control 234 to determine the appropriate protocol to use during transmission.

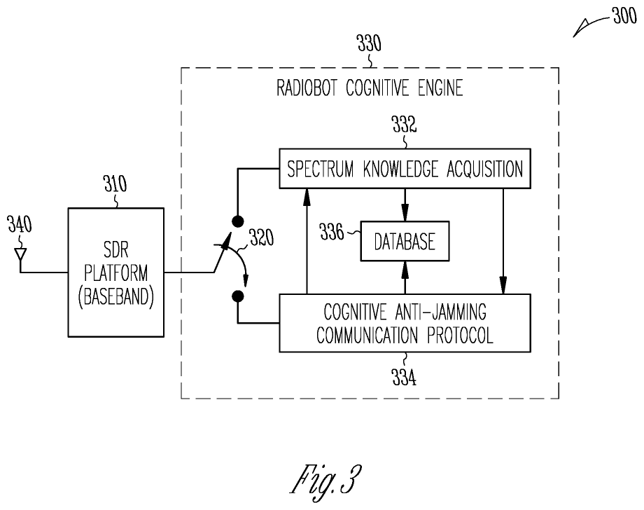

FIG. 3 illustrates another cognitive communications system architecture in accordance with some embodiments. The cognitive communications system 300 may contain elements similar to those shown in FIG. 2, including a software-defined radio 310 and a cognitive engine 330. While FIG. 2 illustrates an FDMA cognitive communications system. FIG. 3 illustrates a TDMA cognitive communications system, in which the same RF chain is time-shared between spectrum sensing and communications operations. Thus, the software-defined radio 310 may be configured to receive signals from and transmit signals to one or more antennas 340. The software-defined radio 310 may be connected to either the acquisition function 332 or the protocol function 334 of the cognitive engine 330 through a switch 320. A database 336 in the cognitive engine 330 may contain parameters for the sensing and communications policies, such as the reward values.

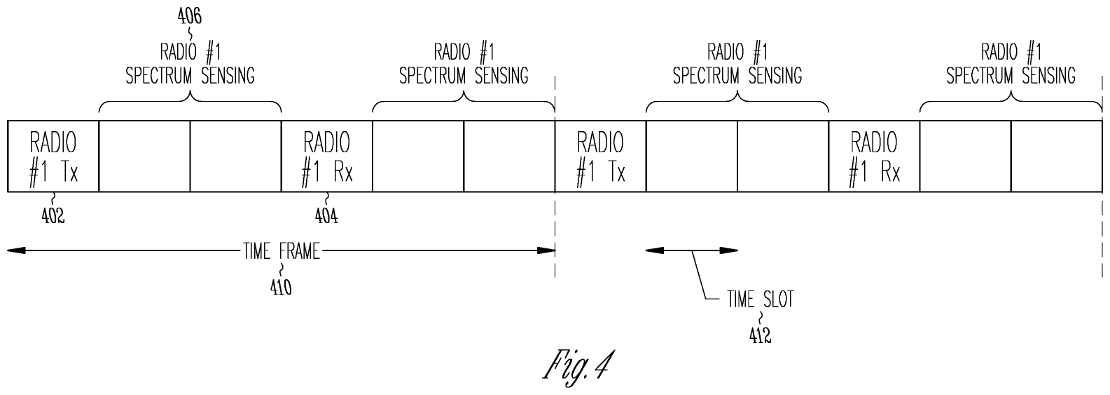

FIG. 4 illustrates operation of the other cognitive communications system architecture in accordance with some embodiments. In particular, FIG. 4 shows a TDMA frame structure in relation to sensing and communication. For example, when sensing and communicating via an LTE network, the TDMA frame structure may be split up into 10 ms radio frames, each of which may contain ten 1 ms subframes. Each subframe of the frame, in turn, may contain two slots of 0.5 ms. Each slot of the subframe may contain 6-7 OFDM symbols, depending on the system used. Each subframe may contain 12 subcarriers. In the 5G system, the frame size (ms) and number of subframes within a frame may be different from that of a 4G or LTE system. The subframe size may also vary in the 5G system from frame to frame. The 5G system may span 5 times the frequency of the LTE/4G system, in which case the frame size of the 5G system may be 5 times smaller than that of the LIE/4G system.

Independent of the system in which the cognitive radio is operating, the time axis may be generalized as shown in FIG. 4; the time axis may be divided into TDMA frames 410 and each frame 410 may be divided into slots 412 of various functionalities. In each frame 410, the cognitive radio may be assigned at least one TX slot 402 and/or at least one RX slot 404. The remaining slots 406 in the frame 410 may be used for spectrum sensing. As shown in FIG. 4, in some embodiments, the number of spectrum sensing slots 406 may be larger than the number of slots used for communications (the TX/RX slots 402, 404).

Independent of whether FDMA or TDMA is used (code division multiple access CDMA may also be used), the cognitive engine may sense the spectrum and communicate on the sensing and communications channels, respectively. The sensing permits cognitive engine to continuously lean and update the sensing and communication policies. Each policy may specify which sub-band or channel the cognitive radio should use next when switching from the current sub-band used for either sensing or communications. Note that in some cases, the spectrum used for sensing and communication may be divided in to a set of sub-bands, each sub-band may contain at least one channel (and possibly multiple channels) whose usage by the cognitive radio may be dynamically determined based on jamming. Each of the sensing and communication policy may be generated and trained through machine-learning.

The use of the machine learning may allow the cognitive radio to adapt to time-varying channel and jammer dynamics, unlike the current, fixed policy-driven radios. Current technologies, even if able to take rudimentary countermeasures, may be susceptible to a smart jammer, which itself may be able to alter behavior based on the radio transmissions. The cognitive anti-jamming system described herein may thus learn in real-time and may be able to accordingly reconfigure its communications mode to rapidly respond to the time-varying channel and jammer dynamics. Unlike other cognitive radios, the sensing and communications policy described below may essentially be a “Plug-n-Play” cognitive engine that avoids replacement of the entire radio. Instead, the cognitive operation is all controlled by signal processing, machine learning and decision-making algorithms implemented in a stand-alone cognitive engine module. This has the ability to interface with third-party, legacy or custom-built SDR platforms to realize a functioning cognitive radio system.

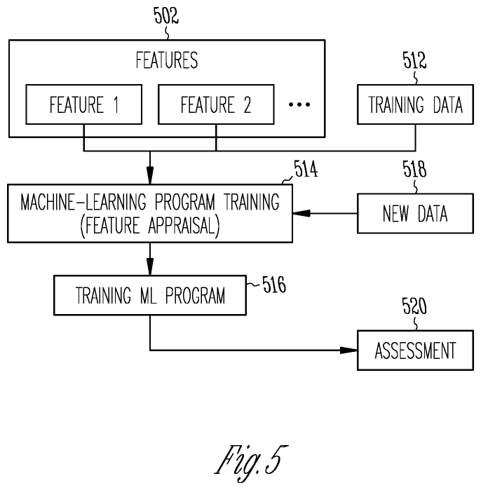

FIG. 5 illustrates training and use of a machine-learning algorithm in accordance with some embodiments. Machine-learning algorithms may be utilized to perform operations associated with neighboring networks. Machine-learning is a field of study that gives computers the ability to learn without being explicitly programmed. Machine-learning explores the study and construction of algorithms, also referred to as tools, that may learn from existing data and make predictions about new data. Such machine-learning tools operate by building a model from example training data 514 to make data-driven predictions or decisions, which are expressed as outputs or assessments 520. Machine learning may be used for various aspects of the system; for example, unsupervised or supervised techniques, such as neural networks (NNs) may be used for signal classification, while unsupervised techniques such as Q-learning may be used for policy learning such as channel interference prediction (sensing policy) and channel usage (communications policy).

Two common types of problems in machine-learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). Supervised machine-learning algorithms utilize the training data 514 to find correlations among identified features 502 that affect the outcome.

The machine-learning algorithms utilize features 502 for analyzing the data to generate assessments 520. A feature 502 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

Supervised machine-learning algorithms utilize the training data 514 to find correlations among the identified features 502 that affect the outcome or assessment 520. In some example embodiments, the training data 514 includes labeled data, which is known data for one or more identified features 502 (such as signal cumulants) and one or more outcomes, such as whether the signal is interference caused by a valid signal or whether the signal is the jammer.

With the training data. 514 and the identified features 502, the machine-learning tool is trained at operation 514. The machine-leaning tool appraises the value of the features 502 as they correlate to the training data 514. The result of the training is the trained machine-learning program 516.

When the machine-learning program 516 is used to perform an assessment, new data 518 is provided as an input to the trained machine-learning program 516. In response, the machine-learning program 516 generates the assessment 520 as output.

Machine-learning techniques train models to accurately make predictions on data fed into the models (e.g., the cumulants). During a learning phase, the models are developed against a training dataset of inputs to optimize the models to correctly predict the output for a given input. The learning phase for signal classification may be supervised, unsupervised or semi-supervised. The various levels of supervision indicate a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations). For example, in a supervised learning phase, a model is developed to predict the output for a given set of inputs. The model may then be evaluated over several epochs to more reliably provide the output that is specified as corresponding to the given input for the greatest number of inputs for the training dataset. In another example of signal classification, for an unsupervised learning phase, a model is developed to cluster the dataset into n groups. The model may then be evaluated over several epochs as to how consistently it places a given input into a given group and how reliably it produces the n desired clusters across each epoch.

Once an epoch is run, the models are evaluated, and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine-learning technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached When the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

In some embodiments, the model includes a neural network which comprises a series of “neurons,” such as Long Short Term Memory (LSTM) nodes, arranged into a network. A neuron is an architectural element used in data processing and artificial intelligence, particularly machine-learning. Each of the neurons used herein are configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance are related to one another.

For example, an LSTM serving as a neuron includes several gates to handle input vectors, a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. Neurons and neural networks may be constructed programmatically (e.g., via software instructions) or via specialized hardware linking each neuron to form the neural network.

Turning to neural networks in particular, as indicated above, neural networks utilize features for analyzing the data to generate assessments. A feature is an individual measurable property of a phenomenon being observed. The concept of feature is related to that of an explanatory variable used in statistical techniques such as linear regression. A neural network, sometimes referred to as an artificial neural network (ANN), is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untamed images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network that is composed of multiple layers (also called as above hidden layers). The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value Which roughly represents its contribution to the original output. Backpropagation can use these error values to calculate the gradient of the cost function with respect to the weights in the neural network. The calculated gradient is fed to the selected optimization method to update the weights to attempt to minimize the cost function.

While a neural network may be used to classify the signal on a particular channel, other learning techniques may also be used in the anti-jamming system. In particular, unsupervised reinforcement learning techniques such as Q-learning may be used to establish a sensing policy that updates a Q table (or matrix) to determine the spectrum usage by jammers and a communication policy that updates a different Q matrix to determine optimal channel usage to avoid the jammer. The sensing and communications policy may eventually be coupled.

One goal of the sensing policy may be to continually follow a jammer that hops channels with a predetermined pattern (initially unknown to the cognitive radio) so that the cognitive radio can adjust the communications channel in advance to avoid the channels used by the jammer. As a result, when the jammer moves from the current sensing sub-band, the sensing policy may predict the sub-band to which the jammer has moved—that is the sub-band that is being interfered with by the jammer if the jammer operates temporally continuously or, if the jammer operates intermittently, will next be interfered with by the jammer. This can be extended if the jammer jams multiple channels simultaneously.

In particular, the cognitive radio may use reinforcement learning, e.g. Q-learning, to establish an effective sensing policy. To meet the objective of tracking the jammer, in some embodiments, the sensing reward function (rₛ) in the reinforcement learning algorithm for the sensing policy may decrease with increasing delay, i.e., rₛ=rₛ₀−λₛtₛ, where r₀ₛ is an initial reward for the sensing channel essentially immediately finding the channel being jammed by the jammer and λₛ is a sensing weight. rₛ₀ may be 0 or some other constant, while λₛ may be a non-negative value that may be constant or change with time. In the latter case, for example, λₛ may increase as a function of the delay in finding the jammer (λₛ=f(tₛ), e.g., λₛ=λₛ₀tₛ or λₛ₀+tₛ). Other possible reward functions may change in a step-wise fashion (e.g., reward x for up to delay a, reward y for delay a to delay b, etc. . . . ). Of course, other reward functionality may also be used.

On the other hand, one objective of the communications policy may be to pick a communications channel that allows the cognitive radio to communicate for the longest time before getting jammed (or otherwise interfered with). In some embodiments, the cognitive radio may switch the current communications channel immediately before the jammer switches to the current communications channel (e.g., in LTE/5G terms, a subframe, slot or even a symbol before the jamming signal switches to the current communications channel). Assuming that the current communications channel does not suffer excessive interference from natural network use, it would be desirable for the cognitive radio to remain in the current communications channel until just before arrival of the jammer signal. Hence, in some embodiments the reward function of the RL algorithms for the communications policy may be made directly proportional to the time that the cognitive radio is able to remain in a channel before getting jammed. Similar to the sensing reward, to meet the objective of remaining on the channel, in some embodiments, the communications reward function (r_{c}) in the reinforcement learning algorithm for the communications policy may change with increasing delay. The communications reward, however, may increase with increasing delay, i.e., r_{c}=r_{c0}+λ_{c}t_{c}, where r_{c0} is an initial reward for the communications channel essentially immediately having to switch channels due to the communications channel being jammed by the jammer and λ_{c} is a communications weight. r_{θc} may be 0 or some other constant, while λ_{c} may be a non-negative value that may be constant or change with time. In the latter case, for example, λ_{c} may increase as a function of the delay in finding the jammer ( λ_{c}=f(t_{c}), e.g., λ_{c}=λ_{c0}t_{c} or λ_{c0}+t_{c}). Other possible reward functions may change in a step-wise fashion (e.g., reward x for up to delay a, reward y for delay a to delay b, etc . . . ). As above, other reward functionality may also be used. The various values (e.g., λₛ, λ_{c}) used in the sensing and communications rewards may be the same or may differ.

The two RL algorithms (for sensing and for communications) may be coupled to help the sensing policy to track the jammer and the communications policy to avoid the jammer effectively. The coupling may be used, for example, in situations where the current communications channel is actually jammed by the jammer before the sensing policy able to alert the cognitive engine to switch the current communications channel to another communications channel. In this case, the current sensing policy may be penalized for whatever action chosen by the current sensing policy at that moment since the current sensing policy was not effective in tracking the jammer. Similarly, the current communications policy may also be penalized for the current action choice since the current communications policy led to the cognitive radio getting jammed due to staying in the current communications channel too long.

The cognitive engine above may also include a jammer discrimination module in the spectrum sensing. The jammer discrimination module may employ a machine-leaning based classifier such as an artificial neural network (ANN) as indicated above. The classifier may be trained to classify the detected signals on the sensing channel into two classes: jammers and valid signals (interference caused by normal network operations). In some embodiments, the classification may be based on one or more parameters of valid signals. The parameters may include, for example, modulation type, modulation order, signal bandwidth and other pertinent information as extracted through features such as higher order statistics (e.g. cumulants of 4^{th} and higher orders), spectral correlation function or cyclic profile. The classifier may be trained using known examples a priori and can be allowed to update its weight vectors during real-time operation. The training can be based on a desired weight update algorithm, such as back propagation or variants thereof.

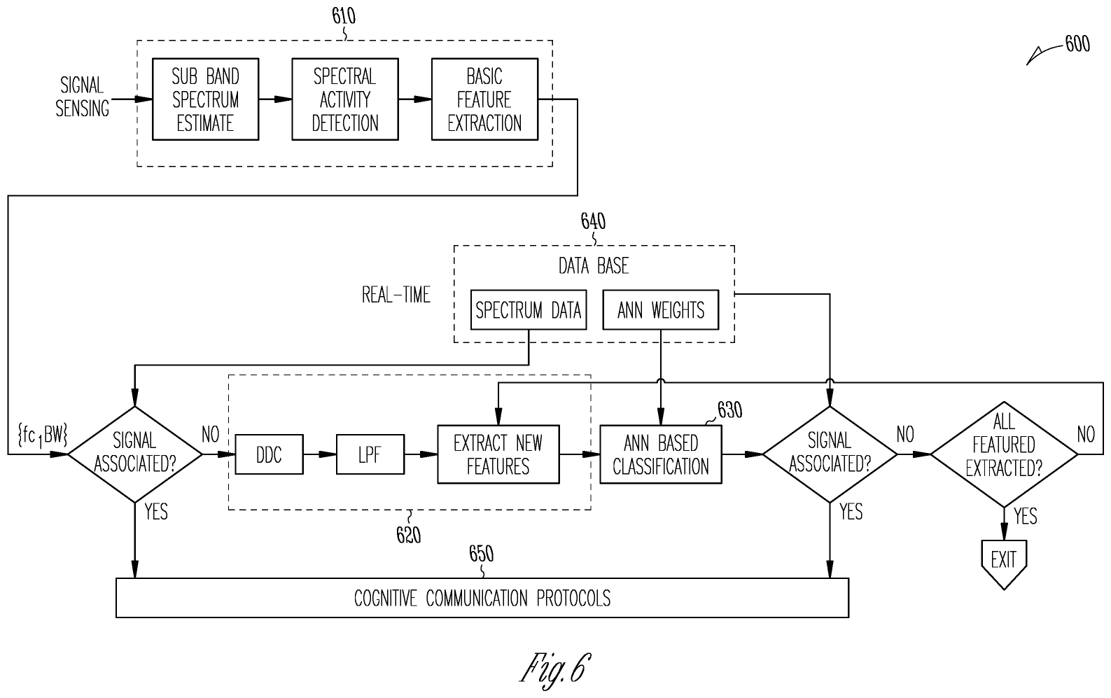

FIG. 6 illustrates a jammer discrimination framework in accordance with some embodiments. The jammer discrimination framework 600 may be based on an approach to extract features in real-time from a sub-band that contains multiple signals at unknown frequencies within the sub-band. The multi-stage hierarchical signal classification and identification framework 600 shown in FIG. 6 may include multiple stages for signal detection 610, signal parameter extraction 620, and signal classification 630.

The framework 600, in some embodiments, may avoid re-acquisition of detected signals at multiple frequencies within the sensed sub-band signal. Each signal may have a different bandwidth, as well as a different center frequency and other characteristics, such as modulation order. The framework 600 may use a series of advanced signal processing steps (stages) to detect and extract in isolation each of the signals in the sub-band signal followed by feature extraction.

As above, in the first stage 610 of the hierarchical signal classification and identification framework 600, all RF signals in the sensed sub-band signal may be detected using a smoothed power spectral density estimator. Next, certain basic features of the individual signals may be estimated in the first stage 610. The estimated features may include, for example, the center-frequencies and approximate bandwidths of the individual detected signals.

The framework 600 may be able to determine whether the signals are actual (valid) network signals from a comparison of the estimated basic features based on information of the spectrum use as stored in a database 640. If the set of estimated features results in classification of the signals, the result may be supplied to the communication protocols 650 associated with the communication policies.

If however, the initial set of features extracted by the first stage 610 fails to allow classification, new features (i.e., non-basic features, such as cumulants indicated below) may be extracted in the second stage 620. The second stage 620 may thus be used to extract feature vectors from the detected and processed signals. The reconfigurable circuitry of the second stage 620 may include a digital down-converter (DDC) (direct digital synthesizer) to down-convert each of the signals in the sub-band to baseband using direct digital synthesized (DDS) carriers. Next a digital low-pass filter (LPF) may be applied to each of the baseband signals to extract the individual signals in isolation. The LPF may be constant or may be adjustable for each signal, dependent on the bandwidth range of the signals.

After low pass filtering the individual baseband signals, the feature vectors of the individual baseband signals may be extracted from these signals and passed on to the ANN. The additional extracted features may include, for example, modulation type, modulation order, and other pertinent information as extracted through features such as higher order statistics (e.g. cumulants of 4^{th} and higher orders), spectral correlation function or cyclic profile. The ANN-based classification may use the ANN weights stored in the database 640. The ANN weights may be applied to different features to increase or decrease the importance of a particular feature in the classification. This latter extraction of new features and attempted ANN-based classification may be continued until a successful classification of the signal is made or all features are extracted and no classification is possible.

The ANN-based classification, like the stage-1 classification, may be used to classify the signals as either valid signals or jamming signals. In some cases, however, the extracted signals may again be insufficient to afford classification. If the new features are again insufficient to allow the ANN to classify the signals, further features, if available, may be iteratively extracted until a classification is obtained or the ANN determines that the classification has failed. For example, although not desirable due to the time and computation power involved, full demodulation and decoding of the signals may be used to classify the signals.

The Hardware-in-the-Loop (HITL) implementation of the above design has been tested with different ANN configurations, depending on the type of signal classification of interest in different scenarios. For example, in situations in which valid signals are known to have certain modulation types and orders, the implementation assumed that the jammers are signals having 64 QAM modulation while all MPSK and 16 QAM are valid signals. In this case, an ANN made of 2 hidden layers with each having 5 neurons was used to perform jammer discrimination successfully. The input layer had 3 neurons corresponding to the 3 input features: two 4^{th} order cumulants (C_40 and C_42) and one 6^{th} order cumulant (C_61). The output layer had a single neuron since the classification was separated into two classes (interference or jamming).

The sensing and communications policy developed by cognitive radios may be used in an end-to-end cognitive anti jamming communications link, along with other control information such as the next one or more communications channels and when these communications channels will be used. The anti jamming communications link used by the cognitive radio receiver can inform the corresponding transmitter (whether or not a cognitive radio) to switch to a new communications channel. The information may be transmitted on the communications link immediately before the current communications channel is jammed or a predetermined amount of time before the current communications channel is predicted to be jammed, assuming that the other radio periodically checks the communications link for an indication of a channel switch (which the cognitive radio will send at the appointed time prior to switching the channel).

The anti-jamming communications link may be achieved by using a set of possible wireless feedback channels (also called control channels). When the current communications channel is jammed, the cognitive radio receiver may provide feedback of the index of the new channel that the transmitter should use over one or more of the feedback channels and immediately switches its current reception to the new communications channel. The cognitive radio receiver may keep listening on the new communications channel until the cognitive radio receiver starts to receive the signal from the transmitter on the new channel.

The feedback channels may be robust channels that are protected against jamming or other interference using various communications-based safeguards. These safeguards may include, for example, heavy error control coding, maximizing the number of retransmissions or transmitting the same information using multiple channels. In some embodiments, a pseudo noise (PN) code may be used to cycle through the set of feedback channels over a relatively long period (e.g., at least several LTE superframes). The PN code may be known to both the cognitive radio receiver and the transmitter so that each time the transmitter can tune to listen to at least one of the feedback channels the cognitive radio receiver will use to convey the next communications channel frequency and perhaps timing information for switching to the next communications channel.

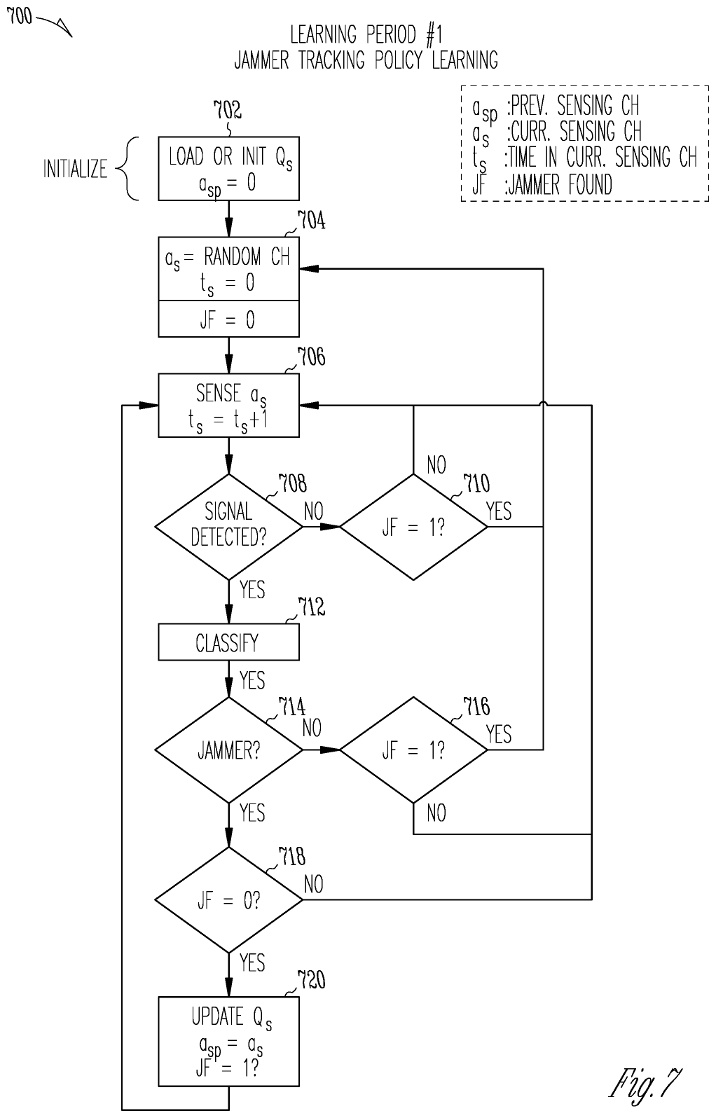

The developed cognitive anti jamming communications system may operate in multiple (e.g., three) steps: Learning period #1. Learning period #2 and the cognitive communications phase. FIG. 7 illustrates a first learning period for the jammer tracking policy in accordance with some embodiments. The flowcharts showing the different periods in FIGS. 7-11 may be performed by any of the devices described above. During Learning period #1 700, the cognitive radio may initially listen only to the channel. The cognitive radio may either learn from scratch or update a previously-learned sensing policy for jammer tracking (also referred to as a jammer tracking policy).

The jammer tracking policy learning 700 may be initiated at operation 702 by loading a sensing matrix Qₛ from a memory of the cognitive radio or initializing the sensing matrix Qₛ. The sensing matrix Qₛ may be a square matrix whose rows indicate the state of the cognitive radio (the current sensing channel) and whose columns indicate the action taken by the radio in response to the state (the next sensing channel), with the value in any intersection indicating the reward for the action taken (the shortest time to find the jammer). The jammer tracking policy learning 700 may use variables that include both the current and previous sensing channel aₛ and aₛₚ, the time spent in the current sensing channel tₛ and whether or not the jammer has been found (JF=1 or jammer found is true). During initialization, the initial previous sensing channel aₛₚ is reset to 0. Note that here, as in all operations that involve initialization/reset of variables, a value other than the value described (0) may be selected.

After initialization of the sensing matrix Qₛ, at operation 704 the current sensing channel aₛ may be randomly selected. The time spent in the current sensing channel tₛ is set to 0, as is JF (no jammer sensed on the current sensing channel aₛ).

At operation 706, the jammer tracking policy may continue to sense the current sensing channel aₛ until the next time increment tₛ+1. The time increment may be determined heuristically or may be predetermined as the maximum desired period for which the jammer is permitted to interfere with the current sensing channel aₛ. This increment may be, for example, I frame, I slot or one or more symbols in LTE or 5G.

At operation 708, the jammer tracking policy may determine whether a signal is detected on the current sensing channel aₛ. The signal may be either a valid signal or the jammer. The signal may be detected using the first stage of the framework shown in FIG. 6.

If a signal is not detected at operation 708, at operation 710 the jammer tracking policy may determine whether the current sensing channel aₛ was previously occupied by the jammer (JF=1). If not, the jammer tracking policy may return to operation 706 and continue to remain on the current sensing channel aₛ until the next time increment. If the jammer tracking policy determines that the current sensing channel aₛ was previously occupied by the jammer, the jammer tracking policy may determine that the jammer is no longer present on the current sensing channel aₛ and returns to operation 704 to randomly select a new current sensing channel aₛ.

If a signal is detected at operation 708, the jammer tracking policy may attempt to classify the signal. The signal may be classified at operation 712 using the framework shown in stages 1 and 2 of FIG. 6. Once the jammer tracking policy classifies the signal at operation 712, the jammer tracking policy may take different actions at operation 714 dependent on whether the jammer tracking policy determines that the signal is the jammer signal.

If the jammer tracking policy determines at operation 714 that the signal is not the jammer signal (i.e., the signal is normal network-based interference), the jammer tracking policy may determine whether the current sensing channel aₛ was previously occupied by the jammer (JF=1). If the jammer tracking policy determines that the current sensing channel aₛ was not previously occupied by the jammer, the jammer tracking policy may return to operation 706 and continue to remain on the current sensing channel aₛ until the next time increment. If the jammer tracking policy determines that the current sensing channel aₛ was previously occupied by the jammer, the jammer tracking policy may determine that the jammer is no longer on the current sensing channel aₛ and returns to operation 704 to randomly select a new current sensing channel aₛ to further track the jammer.

If the jammer tracking policy determines at operation 714 that the signal is the jammer signal, the jammer tracking policy may determine whether the current sensing channel aₛ was previously unoccupied by the jammer at operation 718. If the current sensing channel aₛ was previously occupied by the jammer, the jammer tracking policy may continue to remain on the current sensing channel aₛ and returns to operation 706 until the next time increment (to track whether the jammer has moved during the next time increment).

If the jammer tracking policy determines at operation 718 that the current sensing channel as was previously not occupied by the jammer, the jammer tracking policy may update the sensing matrix Qₛ to indicate that the jammer is present on the current sensing channel aₛ, as well as resetting the previous sensing channel aₛₚ to the current sensing channel aₛ. The jammer tracking policy may return to operation 706 to track whether the jammer has moved during the next time increment.

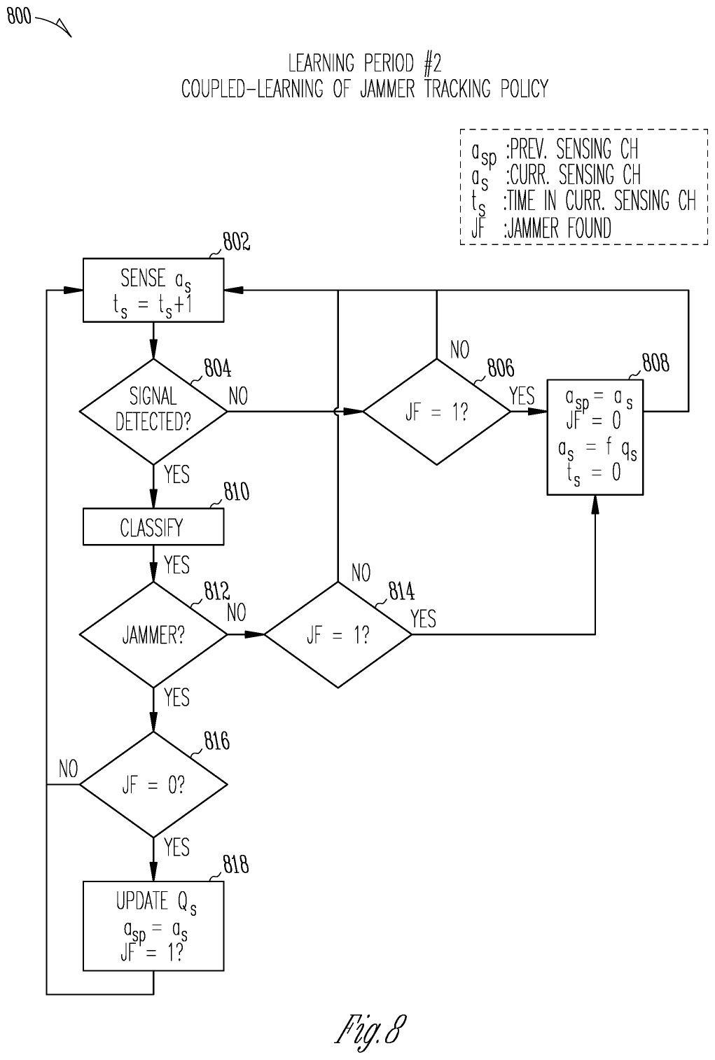

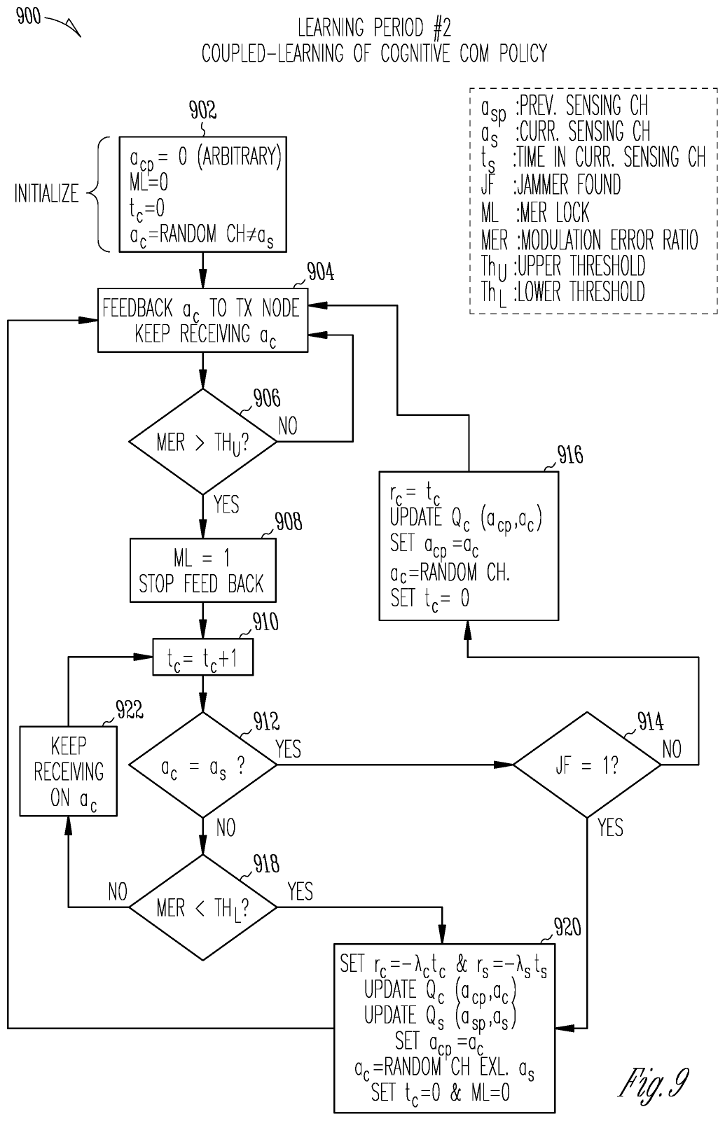

After the initial jammer tracking policy determination, the cognitive radio may start Learning Period #2, as shown in FIG. 8. The cognitive radio may, during this time, learn a cognitive anti jamming communications policy while also tracking the jammer and updating the sensing policy for effective jammer tracking 800. Thus, the jammer policy shown in FIG. 8 is coupled with the communication policy learning, which is shown in FIG. 9. The second learning period may begin at operation 802 in which the current sensing channel aₛ is sensed and the time is incremented.

At operation 804, the jammer tracking policy may determine whether a signal is detected on the current sensing channel aₛ. The signal may be either the jammer or network interference. If a signal is not detected at operation 804, at operation 806 the jammer tracking policy may determine whether the current sensing channel aₛ was previously occupied by the jammer (JF=1). If not, the jammer tracking policy may return to operation 802 and continue to remain on the current sensing channel aₛ until the next time increment. If the jammer tracking policy determines that the current sensing channel as was previously occupied by the jammer, the jammer tracking policy may at operation 808 determine that the jammer is no longer present on the current sensing channel aₛ and update the parameters. To update the parameters, the previous sensing channel aₛₚ may be reset to the current sensing channel aₛ, reset the jammer found indicator to indicate that the jammer is no longer on the channel, select a new channel based on the update the sensing matrix Qₛ and reset the sensing time. The jammer tracking policy may then return to operation 802 and continue to remain on the current sensing channel as until the next time increment.

If a signal is detected at operation 804, the jammer tracking policy may attempt to classify the signal. The signal may be classified at operation 810 using the framework shown in stages 1 and 2 of FIG. 6. Once the jammer tracking policy classifies the signal at operation 810, the jammer tracking policy may take different actions at operation 812 dependent on whether the jammer tracking policy determines that the signal is the jammer signal.

If the jammer tracking policy determines at operation 812 that the signal is not the jammer signal (i.e., the signal is normal network-based interference due to valid signals), the jammer tracking policy may determine whether the current sensing channel aₛ was previously occupied by the jammer (JF=1). If the jammer tracking policy determines that the current sensing channel aₛ was not previously occupied by the jammer, the jammer tracking policy may return to operation 802 and continue to remain on the current sensing channel aₛ until the next time increment. If the jammer tracking policy determines that the current sensing channel aₛ was previously occupied by the jammer, the jammer tracking policy may determine that the jammer is no longer on the current sensing channel aₛ and return to operation 808 to update the parameters to indicate that the jammer has moved (and that the new signal is normal network-based interference).

If the jammer tracking policy determines at operation 812 that the signal is the jammer signal, the jammer tracking policy may determine whether the current sensing channel aₛ was previously unoccupied by the jammer at operation 816. If the current sensing channel aₛ was previously unoccupied by the jammer, the jammer tracking policy may continue to remain on the current sensing channel aₛ and return to operation 802 until the next time increment (to track whether the jammer has moved during the next time increment).

If the jammer tracking policy determines at operation 816 that the current sensing channel aₛ was previously unoccupied by the jammer, the jammer tracking policy may update the sensing matrix Qₛ to indicate that the jammer is present on the current sensing channel aₛ, as well as resetting the previous sensing channel aₛₚ to the current sensing channel aₛ (JF=1). The jammer tracking policy may return to operation 802 to track whether the jammer has moved during the next time increment.

As above, FIG. 9 illustrates a communications policy during Learning Period #2, where the communications policy 900 is coupled with the jammer tracking policy 800 during this portion of the learning process. As shown in FIG. 9, the cognitive radio may at operation 902 initialize the communications policy. The initialization at operation 902 may include setting a previous communications channel a_{cp} to an arbitrary value and setting the time in the current communications channel t₀ to 0. The modulation error ratio (MER) lock may also be set to 0. In other embodiments, an error vector magnitude (EVM) measurement and lock may be used instead of or in addition to the MER. In addition, the communications policy 900 may randomly select channels for communications, as shown on FIG. 7. While random selection may not be the most effective in terms of avoiding an arbitrary jammer, random selection may be effective in terms of allowing the communications policy to learn anti-jamming communications policy. Thus, in other embodiments, rather than being selected randomly, the selection may follow a predetermined pattern.

At operation 904, the communications policy may transmit feedback to the transmitter (or transmitting node). The feedback may be generated by the processor and transmitted via transmission circuitry on, as indicated above, one or more control channels. The feedback may include, for example, the current communications channel index. The transmission on the control channels may be robust and performed such that the receiver is able to decode the information transmitted on the control channels whether or not control channels are affected by the jammer. The cognitive radio may continue to communicate using the current communications channel. Note that in other embodiments, the cognitive radio may be the transmitter and transmit the feedback to a receiver to enable communications on the current communications channel.

At operation 906, the communications policy may determine whether the MER exceeds an upper threshold (THᵤ). In other words, the communications policy may at operation 906 determine whether the signal is the signal expected from the transmitter on the current communications channel. As above, one or more other signal measurements, such as EVM, number of retransmissions or modulation order, for example, may be used in addition to or instead of MER. If the upper threshold has not been exceeded, the communications policy may return to operation 904, the cognitive radio may continue to communicate on the current communications channel. In some embodiments, the communications policy may provide feedback to the transmitter (e.g., at predetermined periods) to confirm that communications are continuing on the current communications channel. In other embodiments, such feedback may be provided only if the communications channel has changed or is going to change.

If at operation 906, the communications policy determines that the MER exceeds the upper threshold, the communications policy may at operation 908 set the MER lock to true (MER lock=1). The communications policy may also terminate feedback to the transmitter and, at operation 910, increment the current communications time (i.e., wait) prior to proceeding.

After incrementing the current communications time at operation 910, the communications policy may determine from the (coupled) sensing policy at operation 912 whether the current communications channel is the same as the current sensing channel. If the current communications channel is the same as the current sensing channel, at operation 914 the communications policy may determine whether the sensing policy has determined that the jammer is present on the current communications channel (JF=1).

If at operation 914 the communications policy determines that the jammer is not present on the current communications channel (i.e., the MER is due to interference caused by normal network usage), the communications policy may at operation 916, among others set the reward and update the communications matrix. In particular, the communications reward (r_{c}) may be set to the time spent on the current communications channel and the matrix element representing the previous and current communications channels updated accordingly. Thus, there is no penalty to communicate on the current communications channel due to network interference. The communications policy may also set the current communications channel as the previous communications channel and subsequently randomly select a new current communications channel due to the network interference and reset the time on the current communications channel. The communications matrix Q_{c}, like the sensing matrix Qₛ, may be a square matrix whose rows indicate the state of the cognitive radio (the current communications channel) and whose columns indicate the action taken by the radio in response to the state (the next communications channel), with the value in any intersection indicating the reward for the action taken (switching to the channel with the longest time period before being jammed).

After performing the operations at operation 916, the communications policy may then return to operation 904, the cognitive radio continuing to communicate using the current communications channel and perhaps provide feedback to the transmitter to indicate that the current communications channel has not changed. If, however, the communications policy determines at operation 914 that the jammer is present on the current communications channel, the communications policy may advance to operation 920, described below.

If the communications policy determines at operation 912 that the current communications channel is not the same as the current sensing channel, the communications policy may determine at operation 918 whether the MER is less than a lower threshold (TH_{L}). This is to say that the communications policy may determine whether the network-based interference is substantial enough to warrant switching the current communications channel. The upper and lower thresholds may be set heuristically, for example. If the communications policy determines at operation 918 that the MER (or other measurement) is better than the acceptable threshold, the communications policy may at operation 922 determine that the network interference is acceptable and continue receiving on the current communications channel before returning to operation 910.

If, however, the communications policy determines at operation 918 that the MER is unacceptable (or if the communications policy determines at operation 914 that the current communications channel is the sensing channel and the jammer is occupying the sensing/communications channel), the communications policy may implement the steps at operation 920. In particular, the communications policy may at operation 920 learn that the cognitive radio has remained on the current communications channel too long as the jammer is occupying the current communications channel. Thus, both the communications policy and the sensing policy are trained by penalizing for remaining on the same channel that the jammer occupies. As indicated above, the communications reward (r_{c}) may be reduced (or increasingly negative) proportional to the length of time that the cognitive radio continues to receive on the current communications channel (t_{c}). Similarly, the sensing reward (rₛ) may be reduced (or increasingly negative) proportional to the length of time that the cognitive radio continues to sense the current sensing channel (tₛ). The communication and sensing reward weights (λ_{c}, λₛ) may be determined heuristically and may be the same in some embodiments or may differ in other embodiments. The communication and sensing weights may be constant in time or otherwise vary, as described in more detail above. The use of negative reinforcement may permit the communications and sensing matrices (and path weights of the neural network) to be updated effectively to subsequently avoid the jammer.

After updating the sensing and communications matrices based on the previous sensing and communications channel, respectively, and the current sensing and communications channel, respectively, the communications policy may at operation 920 randomly select a new current communications channel. Selection of the new current communications channel, however, may be limited to exclude the current sensing channel. The communications policy may then reset the MER lock to 0 and the current time to 0 before proceeding to operation 904 and providing feedback to the transmitter about the new communications channel.

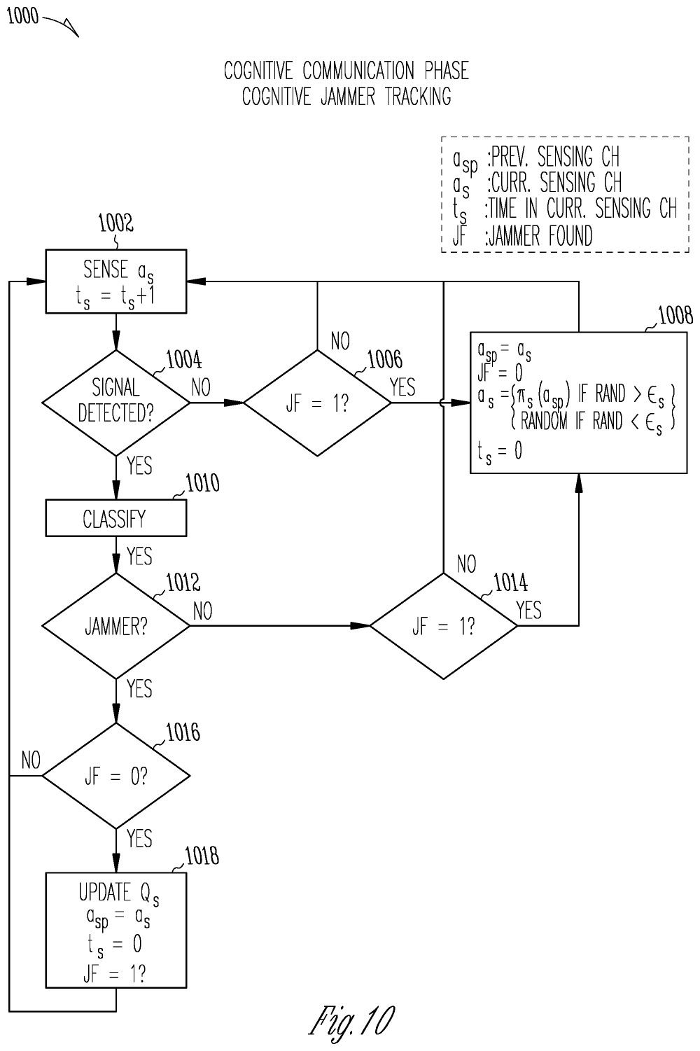

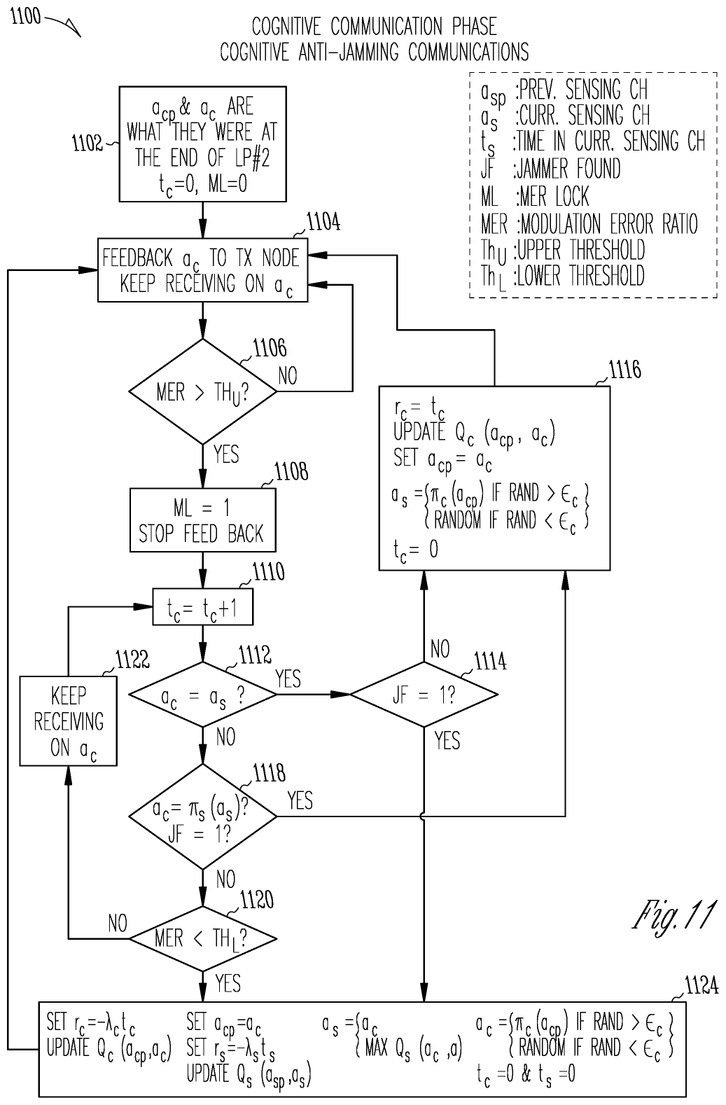

At the end of the LP #2 shown in FIGS. 8 and 9, the cognitive radio may initiate a cognitive anti-jamming communications phase. In this phase the cognitive radio may use the teamed sensing and communications policies. FIG. 10 illustrates jammer tracking during a communication phase in accordance with some embodiments while FIG. 11 illustrates communication phase anti-jamming in accordance with some embodiments. In one embodiment, during the phase shown in FIGS. 10 and 11, the cognitive radio may explore random channels as denoted by two exploration rates, one for sensing policy and one for the cognitive anti jamming communications policy. This may allow the cognitive radio to continuously update its policies in order to keep up with time-varying channel and jammer dynamics.

The cognitive anti jamming communications operation of the developed cognitive anti-jamming communications system 1000 as shown in FIG. 10, may start at operation 1002 by sensing the current sensing channel and incrementing the time counter in the current sensing channel. At operation 1004, the sensing policy may determine whether an interfering signal is detected in the current sensing channel.

If the sensing policy determines that no signal has been detected, at operation 1006 the sensing policy may determine whether the jammer found indicator is true at the current sensing channel (i.e., indicates that the jammer is supposed to be at the current sensing channel). If not, the sensing policy may return to operation 1002, advance the current sensing time and continue to sense the current sensing channel. If the sensing policy determines that the jammer found indicator is true at the current sensing channel, the sensing policy may take several actions at operation 1008 to update the sensing policy. In particular, the sensing policy may set the previous sensing channel to the current sensing channel, and reset the jammer found indicator to false and reset the current sensing time.

In addition, as above, since no signal has been detected nor is supposed to be detected at the current sensing channel, the cognitive radio may sense a random channel with a sensing exploration rate/probability (εₛ). In other words, a random number between 0 and 1 may be generated. If the random number is less than the sensing exploration probability, the sensing policy may randomly select another sensing channel (aₛ is selected randomly). If the random number is equal to or greater than the sensing exploration rate, the sensing policy may select the next sensing channel as indicated by the sensing policy function (πₛ) developed in FIGS. 7 and 8. The sensing exploration rate of random selection may be determined heuristically and may be small (e.g., 1-10%), for example.

If the sensing policy determines that a signal has been detected, at operation 1010 the sensing policy may classify the signal. The classification may use the methodology described above and may be used at operation 1012 to determine whether the signal is the jammer or network interference.

If the sensing policy determines that the signal is not the jammer, at operation 1014, the sensing policy may determine whether the jammer found indicator is true at the current sensing channel. If not, the sensing policy may determine that no jammer was previously indicated in the current sensing channel at the current sensing time and return to operation 1002, continuing to sense the current sensing channel. If the sensing policy determines that the jammer found indicator is true at the current sensing channel, the sensing policy may return to operation 1008, performing the operations to reset the functions and either adjust the channel to the next channel previously determined by the sensing policy or select a random channel.

If the sensing policy determines that the signal is the jammer, at operation 1016 the sensing policy may determine whether the jammer found indicator is false at the current sensing channel. If the jammer found indicator is true at the current sensing channel, the sensing policy may determine that the sensing policy is correct and return to operation 1002. If the jammer found indicator is false at the current sensing channel, the sensing policy may determine that the sensing policy should be updated. Thus, at operation 1018, the sensing policy may update the sensing matrix to indicate that the jammer found is true at the current sensing channel before setting the previous sensing channel as the current sensing channel, resetting the sensing time and returning to operation 1002.

As shown in FIG. 11, the cognitive communication phase cognitive anti-jammer communications 1100 may start at operation 1102 by sensing the current sensing channel and incrementing the time counter in the current sensing channel. At operation 1102, the communications policy may maintain the current and previous communications channel from the end of the second learning phase shown in FIG. 9. The current communications time and the MER lock may be reset. At operation 1104, the communications policy may transmit feedback to the transmitter on one or more control channels. The control channels may be the same as those used during the second training period or may be control channels that are reserved for the communications phase. The cognitive radio may continue to communicate using the current communications channel.

At operation 1106, the communications policy may determine whether the MER exceeds the upper threshold. If the upper threshold has not been exceeded, the communications policy may return to operation 1104, the cognitive radio may continue to communicate on the current communications channel and provide feedback to the transmitter. If at operation 1106, the communications policy determines that the MER exceeds the upper threshold, the communications policy may at operation 1108 set the MER lock to true. The communications policy may also terminate feedback to the transmitter and, at operation 1110, increment the current communications time after continuing to receive on the current communications channel. The granularity of the time increment may be predetermined such as an LTE or 5G slot or frame. Alternatively, the time increment may be dependent on internal factors such as the data importance or application generating the data (e.g., the more important the data, the smaller the time period to determine whether the data is being communicated effectively) or external factors such as the potential for network interference (e.g., if there are known times that network traffic is likely to increase, the smaller the time period to permit a quicker response if network-based interference occurs). Although not shown, the time increment may change at predetermined times or upon an event occurring (e.g., every time the jammer or network interference causes a communications channel change).

After incrementing the current communications time at operation 1110, the communications policy may determine from the sensing policy at operation 1112 whether the current communications channel is the same as the current sensing channel. If the current communications channel is the same as the current sensing channel, at operation 1114 the communications policy may determine whether the sensing policy has determined that the jammer is present on the current communications channel—that is, the jammer found indicator is true.

If the communications policy determines that the jammer found indicator is not true (that is, the signal is network interference), at operation 1116 the communications policy may take several actions update the communications matrix. In particular, the communications policy may set the previous communications channel to the current communications channel, and reset the current sensing time. In addition, the cognitive radio may sense a random channel with a communications exploration rate/probability (εₛ). If the random number is less than the communications probability, the communications policy may randomly select another communications channel (a_{c} is selected randomly). If the random number is equal to or greater than the communications exploration rate, the communications policy may select the next communications channel as indicated by the communications policy function (π_{c}) developed in FIGS. 7 and 8. The communications exploration rate of random selection may be determined heuristically and may be small (e.g., 1-10%), for example. The sensing and communications probabilities may be the same or may be different. In addition, as the jammer has not affected the current communications channel, the communications policy may earn a reward (r_{c}) that is proportional to the amount of time the current communications channel has been used. In some embodiments, such as that shown in FIG. 11, the weights (λ_{c}, λₛ) may be a constant and, in particular, equal to 1.

If the communications policy determines that the jammer found indicator is true at operation 1114, the communications policy may determine that the cognitive radio has remained on the communications channel too long and may take several actions indicated at operation 1124, described in more detail below.

If the communications policy determines at operation 1112 that the current communications channel is the same as the current sensing channel, the communications policy response may vary dependent on whether the current communications channel was randomly selected or selected by the communications policy, as indicated at operation 1118. In addition, the response may depend on whether the jammer function indicator is true. If the current communications channel was randomly selected, the communications policy may return to operation 1116.

If the current communications channel was selected by the communications policy, the communications policy may determine at operation 1120 whether the MER is less than the lower threshold. If not, the communications policy may at operation 1122 determine that the interference is relatively insignificant and continue to receive at the current communications channel. The communications policy may then return to operation 1110 and increment the time.

If the current communications channel was selected by the communications policy and the communications policy determines at operation 1120 whether the MER is less than the lower threshold, the communications policy may at operation 1124 update the communications policy. In particular, the communications policy may determine that the cognitive radio has remained on the current communications channel too long and the sensing policy and communications policy have failed as the jammer is occupying the current communications channel. Thus, both the communications policy and the sensing policy are penalized for deliberate selection of the same channel that the jammer occupies. This is shown in operation 1122, in which the communications reward (r_{c}) may be negatively proportional (−λ_{c}) to the length of time that the cognitive radio continues to receive on the current communications channel (t_{c}) while the jammer is present. Similarly, the sensing reward (rₛ) may be negatively proportional (−λₛ) to the length of time that the cognitive radio takes to find the current sensing channel (tₛ). The communication and sensing weights (λ_{c}, λₛ) may be determined heuristically and may be the same or may differ. In some embodiments, the communication and sensing weights may be the same as those used during the second learning period, while in other embodiments the communication and sensing weights may differ from those used during the second learning period. The communication and sensing weights may be constant in time or otherwise vary as above.

The use of negative reinforcement may permit the communications and sensing matrices to be updated effectively to subsequently avoid the jammer. The performance of the cognitive radio, and thus, system can be characterized by two basic performance metrics: the average sensing time the sensing policy takes to observe the jammer in a new sensing channel and the average communications time the communications policy allows the communications link between the cognitive radio and the transmitter (or receiver) to operate in a new communications channel before switching without getting jammed or otherwise interfered with. When the system operates successfully, the average communications time may be as large as possible while the average sensing time may be as small as possible.

In addition to updating the communications and sensing matrices, at operation 1124, the communications policy may set the current communications channel as the previous communications channel and choose a new communications channel. As above, selection of a new communications channel as the current communications channel may be based on the communications policy or may be a random selection, depending on whether a randomly generated number is greater or less than the communications exploration rate. The new sensing channel may be set to either the randomly selected new communications channel or to that given by the policy which is the column index corresponding to the maximum entry in the row corresponding to the current communications channel. Further, the sensing and communications times are reset prior to the communications policy returning to operation 1104.

The reinforcement learning indicated in the coupled jammer tracking and anti-jamming communications methodology shown in FIGS. 10 and 11 may provide continuous reinforcement learning for the sensing and communications policies. The continuous reinforcement learning for the sensing and communications policies, and thus the cognitive radio system may be applicable for various types of intermittent jammers including smart jammers that may also learn which channels to jam.

The technology describe above may result in a complete end-to-end, closed loop cognitive anti jamming communications system. The cognitive anti jamming communications system has been designed, developed, implemented in both HITL simulations as well as in hardware. The system may use heavily protected and encrypted feedback channels for frequency rendezvous of transmitter and receiver nodes of a communications link. The system incorporates jammer identification through machine learning-based classification.

As above, multiple signals may be able to be extracted in isolation from a sub-band signal without individual re-acquisition of the time-domain signals, unlike technologies that require the radio to reconfigure its RF front-end to tune into individual signal channels and re-acquire the signals one by one. The described method may avoid such re-acquisition by processing the original sub-band signal that contains the multiple signals through a series of advanced signal processing steps. The method may use digital down conversion followed by digital low-pass filtering to extract several signals contained in the same sub-band signal. The DDC may use digitally synthesized carriers of frequencies of each detected signal. An LPF may use cut-off frequencies based on the estimated bandwidth of the detected signals.

Jammer discrimination via machine learning may be based on higher order statistics features of the signals (e.g. cumulants) in combination with a cyclic profile and spectral correlation function. The system may define two classes of signals: valid signals and jammers/interference. The signal classification may be used in coupled learning processes to achieve cognitive anti-jamming. This is to say that one learning algorithm may track one or more jammers while another learning algorithm may learn an effective communications policy. The two learning processes may be coupled through penalties for remaining too long in a communications channel and getting jammed and not being able to predict the jammer to warn the communications link before the communications link gets jammed.

### EXAMPLES

Example 1 is an apparatus of a cognitive radio, the apparatus comprising: processing circuitry arranged to: train each of a sensing and communications policy using reinforcement learning (RL) to track and avoid a jammer; classify a detected signal on a sensing channel using an artificial neural network (ANN), the ANN having an input neuron of a parameter of the interference, a hidden layer comprising multiple neurons, and an output neuron that provides ANN-based classification of a detected signal on the sensing channel, the ANN-based classification selected from the jammer and a valid network signal; and after initial training of each of the sensing and communications policy: the sensing policy configures the cognitive radio to determine whether the jammer is present on a current sensing channel and the communications policy configures the cognitive radio to communicate using a current communications channel, and the sensing and communications policies are coupled using a reward that penalizes both the sensing and communications policies when the current communications channel is jammed by the jammer before the sensing policy indicates presence of the jammer and the communications policy switches the current communications channel to a different communications channel; and a memory configured to store parameters used for the RL.

In Example 2, the subject matter of Example 1 includes, wherein the processor is configured to define a cognitive engine in the cognitive radio, at least sonic of elements in the cognitive radio being defined by a software-defined radio (SDR).

In Example 3, the subject matter of Examples 1-2 includes, wherein: the processor is configured to generate feedback over a control channel to another radio with which the cognitive radio is in communication, the feedback comprises identification of the current communications channel, and the control channel employs heavy error control coding to protect the feedback against interference by the jammer.

In Example 4, the subject matter of Examples 1-3 includes, wherein the input layer comprises 3 neurons corresponding to two 4^{th} order cumulants (C_40 and C_42) and one 6^{th} order cumulant (C_61).

In Example 5, the subject matter of Example 4 includes, wherein classification of the detected signal is based on a combination of the cumulants with cyclic profile and spectral correlation of the detected signal.

In Example 6, the subject matter of Examples 1-5 includes, wherein the processor is further configured to: initially attempt to classify the detected signal by extraction of basic features, the basic features including a center frequency and bandwidth of the detected signal in the sub-band; and undertake the ANN-based classification when initial classification using the basic features is unable to classify the detected signal.

In Example 7, the subject matter of Example 6 includes, wherein the ANN-based classification comprises: down-conversion of the detected signal to a baseband signal by a direct digital synthesizer; filtering of the baseband signal by a low pass filter to form a low pass filtered signal; extraction of non-basic features of the signal from the low pass filtered signal; and attempting the ANN-based classification using the non-basic features and weights stored in the memory.

In Example 8, the subject matter of Examples 6-7 includes, wherein: the detected signal is received in a sub-band signal comprising multiple received signals that are received without retuning of the cognitive radio, and the processor is further configured to initially attempt to individually classify each of the received signals by extraction of the basic features of the received signal and undertake the ANN-based classification when initial classification using the basic features of the received signal is unable to classify the received signal.

In Example 9, the subject matter of Examples 1-8 includes, wherein: the initial training comprises first and second training periods, in the first training period the sensing policy is trained without the communications policy being trained, and in the second training period: each of the sensing and communications policy is trained, the communications policy being initially trained and the sensing policy being updated, and training of the sensing and communications policy is coupled using the reward to penalize both the sensing and communications policies when the current communications channel is jammed by the jammer before the communications policy switches the current communications channel to a different communications channel.

In Example 10, the subject matter of Examples 1-9 includes, wherein: after initial training of the communications policy, the communications policy is configured to use an upper and lower threshold, the upper threshold is used to determine whether the detected signal is a signal expected from another radio on the current communications channel, and the lower threshold is used to determine whether to continue to communicate on the current communications channel after a determination that: the upper threshold has been exceeded, the current sensing and communications channel are different, and the sensing policy indicates that the jammer is not in the current communications channel.

In Example 11, the subject matter of Examples 1-10 includes, wherein the processor is further configured to: select a new communications channel, independent of whether the sensing policy indicates that the jammer is in the current communications channel, in response to a determination that: the detected signal is significant enough to interfere with communication on the current communications channel between the cognitive radio and another radio, and the current sensing and communications channel are the same.

In Example 12, the subject matter of Example 11 includes, wherein the processor is further configured to: generate a random number between 0 and 1; randomly select the new communications channel when the random number is less than a communications exploration rate of random selection stored in the memory, and when the random number is at least that of the communications exploration rate, select the new communications channel based on a communications channel likely to have a longest time without interference generated by the jammer as determined by the communications policy.

In Example 13, the subject matter of Examples 1-12 includes, wherein: the reward for each of the sensing and communications policy is proportional to a time spent in the communications channel when the jammer is transmitting on the current communications channel, and the sensing and communications policy have weights associated with the reward that are independent of each other.

Example 14 is a computer-readable storage medium that stores instructions for execution by one or more processors of a cognitive radio, the one or more processors to configure the cognitive radio to, when the instructions are executed: train each of a sensing and communications policy using reinforcement learning (RL) to track and avoid a jammer; classify a detected signal on a sensing channel using an artificial neural network (ANN), the ANN having input neurons of higher order cumulants of the detected signal and an output neuron that provides ANN-based classification of the detected signal, the ANN-based classification selected from the jammer and a valid network signal; and couple the sensing and communications policy during communication by penalizing the sensing and communications policy using a sensing reward comprising a sensing weight times a sensing time and a communications reward comprising a communications weight times a communications time, the sensing time being a time the sensing policy has taken to determine presence of the jammer on a current sensing channel, and the communications time being a time the communications policy has allowed the cognitive radio to be jammed on a current communications channel by the jammer.

In Example 15, the subject matter of Example 14 includes, wherein the instructions further configure the cognitive radio to: generate feedback over a control channel to another radio with which the cognitive radio is in communication, wherein the feedback comprises identification of a new communications channel for communication with the cognitive radio, the control channel is different from the current sensing and communications channels, the feedback provided in response to a determination of jamming of the current communications channel, and use heavy error control coding to protect the feedback against interference by the jammer.

In Example 16, the subject matter of Examples 14-15 includes, wherein the instructions further configure the cognitive radio to: initially attempt to classify the detected signal by extraction of basic features, the basic features including a center frequency and bandwidth of the detected signal, undertake the ANN-based classification when initial classification using the basic features is unable to classify the detected signal, wherein the ANN-based classification comprises: down-converting the detected signal to a baseband signal by a digital down-converter that uses direct digital synthesis; filtering the baseband signal by a low pass filter to filter to form a low pass filtered signal; extracting non-basic features of the signal from the low pass filtered signal; and attempting the ANN-based classification using the non-basic features and trained weights.

In Example 17, the subject matter of Examples 14-16 includes, wherein the instructions further configure the cognitive radio to: train the sensing policy during first and second training periods and train the communications policy during second training period but not the first training period, and couple training of the sensing and communications policies during the second training period using the sensing and communications rewards.

In Example 18, the subject matter of Examples 14-17 includes, wherein: the instructions further configure the cognitive radio to: determine that the detected signal is significant enough to interfere with communication on the current communications channel, generate a random number independent of whether the sensing policy indicates that the jammer is in the current communications channel, randomly select a new communications channel when the random number is less than a communications exploration rate of random selection, and when the random number is at least that of the communications exploration rate, select the new communications channel based on a communications channel likely to have a longest time without interference generated by the jammer as determined by the communications policy.

Example 19 is a method of implementing machine-learning in a cognitive radio to avoid a jammer, the method comprising: detecting activity in a sub-band using a smoothed power spectral density estimator; extracting a center frequency and bandwidth of each signal within the sub-band; attempting to classify each signal as either a valid network signal or a jammer using the center frequency and bandwidth of the signal; in response to failing to classify one of the signals using the center frequency and bandwidth of the one of the signals, attempting to classify the one of the signals using an artificial neural network (ANN)-based classification by using an ANN having input neurons of higher order cumulants of a sensing channel and an output neuron that provides the ANN-based classification of the one of the signals on the sensing channel, the ANN-based classification selected from the jammer and valid network signals; training a sensing and communications policy to respectively track and avoid a jammer using multiple learning periods, and subsequently coupling the sensing and communications policy during communication using a current communications channel, the sensing and communications policy coupled by a sensing reward comprising a sensing weight times a sensing time and a communications reward comprising a communications weight times a communications time, the sensing time being a time the sensing policy has taken to determine presence of the jammer on a current sensing channel, and the communications time being a time the communications policy has allowed the cognitive radio to be jammed by the jammer, the sensing and communications weights being a negative value; and avoiding communicating on the current communications channel when the jammer is present on the current communications channel in response to identifying a detected signal on the current communications channel as the jammer.

In Example 20, the subject matter of Example 19 includes, generating feedback over a control channel to another radio from which the cognitive radio is receiving a signal, wherein the feedback comprises identification of a new communications channel for communication with the cognitive radio, the control channel is different from the current sensing and communications channels, the feedback provided in response to the identifying of the detected signal on the current communications channel as the jammer_{;} and taking communications-based safeguards to protect the feedback against interference by the jammer.

In Example 21, the subject matter of Examples 19-20 includes, generating a random number independent of whether the sensing policy indicates that the jammer is in the current communications channel, randomly selecting a new communications channel when the random number is less than a communications exploration rate of random selection, and when the random number is at least that of the communications exploration rate, selecting the new communications channel based on a communications channel likely to have a longest time without interference generated by the jammer as determined by the communications policy.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

Although an aspect has been described with reference to specific example aspects, it will be evident that various modifications and changes may be made to these aspects without departing from the broader scope of the present disclosure. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single aspect for the purpose of streamlining the disclosure. This method of disclosure is not to be interpreted as reflecting an intention that the claimed aspects require more features than are expressly recited in each claim. Rather, as the following claims reflect, inventive subject matter lies in less than all features of a single disclosed aspect. Thus, the following claims are hereby incorporated into the Detailed Description, with each claim standing on its own as a separate aspect.

What is claimed is:

1. An apparatus of a cognitive radio, the apparatus comprising:
processing circuitry arranged to:
train each of a sensing and communications policy using reinforcement learning (RL) to track and avoid a jammer;
classify a detected signal on a sensing channel using an artificial neural network (ANN), the ANN having an input neuron of a parameter of the interference, a hidden layer comprising multiple neurons, and an output neuron that provides ANN-based classification of a detected signal on the sensing channel, the ANN-based classification selected from the jammer and a valid network signal; and
after initial training of each of the sensing and communications policy:
the sensing policy configures the cognitive radio to determine whether the jammer is present on a current sensing channel and the communications policy configures the cognitive radio to communicate using a current communications channel, and
the sensing and communications policies are coupled using a reward that penalizes both the sensing and communications policies when the current communications channel is jammed by the jammer before the sensing policy indicates presence of the jammer and the communications policy switches the current communications channel to a different communications channel; and
a memory configured to store parameters used for the RL.

2. The apparatus of claim 1, wherein the processor is configured to define a cognitive engine in the cognitive radio, at least some of elements in the cognitive radio being defined by a software-defined radio (SDR),

3. The apparatus of claim 1, wherein:
the processor is configured to generate feedback over a control channel to another radio with which the cognitive radio is in communication,
the feedback comprises identification of the current communications channel,and
the control channel employs heavy error control coding to protect the feedback against interference by the jammer.

4. The apparatus of claim 1, wherein the input layer comprises 3 neurons corresponding to two 4^{th} order cumulants (C_40 and C_42) and one 6^{th} order cumulant (C_61).

5. The apparatus of claim 4, wherein classification of the detected signal is based on a combination of the cumulants with cyclic profile and spectral correlation of the detected signal.

6. The apparatus of claim 1, wherein the processor is further configured to:
initially attempt to classify the detected signal by extraction of basic features, the basic features including a center frequency and bandwidth of the detected signal in the sub-band; and
undertake the ANN-based classification when initial classification using the basic features is unable to classify the detected signal.

7. The apparatus of claim 6, wherein the ANN-based classification comprises:
down-conversion of the detected signal to a baseband signal by a direct digital synthesizer;
filtering of the baseband signal by a low pass filter to form a low pass filtered signal;
extraction of non-basic features of the signal from the low pass filtered signal; and
attempting the ANN-based classification using the non-basic features and weights stored in the memory.

8. The apparatus of claim 6, wherein:
the detected signal is received in a sub-hand signal comprising multiple received signals that are received without retuning of the cognitive radio, and
the processor is further configured to initially attempt to individually classify each of the received signals by extraction of the basic features of the received signal and undertake the ANN-based classification when initial classification using the basic features of the received signal is unable to classify the received signal.

9. The apparatus of claim 1, wherein:
the initial training comprises first and second training periods,
in the first training period the sensing policy is trained without the communications policy being trained, and
in the second training period:
each of the sensing and communications policy is trained, the communications policy being initially trained and the sensing policy being updated, and
training of the sensing and communications policy is coupled using the reward to penalize both the sensing and communications policies when the current communications channel is jammed by the jammer before the communications policy switches the current communications channel to a different communications channel.

10. The apparatus of claim 1, wherein:
after initial training of the communications policy, the communications policy is configured to use an upper and lower threshold,
the upper threshold is used to determine whether the detected signal is a signal expected from another radio on the current communications channel, and
the lower threshold is used to determine whether to continue to communicate on the current communications channel after a determination that:
the upper threshold has been exceeded,
the current sensing and communications channel are different, and
the sensing policy indicates that the jammer is not in the current communications channel.

11. The apparatus of claim 1, wherein the processor is further configured to:
select a new communications channel, independent of whether the sensing policy indicates that the jammer is in the current communications channel, in response to a determination that:
the detected signal is significant enough to interfere with communication on the current communications channel between the cognitive radio and another radio, and
the current sensing and communications channel are the same.

12. The apparatus of claim 11, wherein the processor is further configured to:
generate a random number between 0 and 1;
randomly select the new communications channel when the random number is less than a communications exploration rate of random selection stored in the memory, and
when the random number is at least that of the communications exploration rate, select the new communications channel based on a communications channel likely to have a longest time without interference generated by the jammer as determined by the communications policy.

13. The apparatus of claim 1, wherein:
the reward for each of the sensing and communications policy is proportional to a time spent in the communications channel when the jammer is transmitting on the current communications channel, and
the sensing and communications policy have weights associated with the reward that are independent of each other.

14. A computer-readable storage medium that stores instructions for execution by one or more processors of a cognitive radio, the one or more processors to configure the cognitive radio to, when the instructions are executed:
train each of a sensing and communications policy using reinforcement learning (RL) to track and avoid a jammer;
classify a detected signal on a sensing channel using* an artificial neural network (ANN), the ANN having input neurons of higher order cumulants of the detected signal and an output neuron that provides ANN-based classification of the detected signal, the ANN-based classification selected from the jammer and a valid network signal; and
couple the sensing and communications policy during communication by penalizing the sensing and communications policy using a sensing reward comprising a sensing weight times a sensing time and a communications reward comprising a communications weight times a communications time, the sensing time being a time the sensing policy has taken to determine presence of the jammer on a current sensing channel, and the communications time being a time the communications policy has allowed the cognitive radio to be jammed on a current communications channel by the jammer.

15. The medium of claim 14, wherein the instructions further configure the cognitive radio to:
generate feedback over a control channel to another radio with which the cognitive radio is in communication, wherein the feedback comprises identification of a new communications channel for communication with the cognitive radio, the control channel is different from the current sensing and communications channels, the feedback provided in response to a determination of jamming of the current communications channel, and
use heavy error control coding to protect the feedback against interference by the jammer.

16. The medium of claim 14, wherein the instructions further configure the cognitive radio to:
initially attempt to classify the detected signal by extraction of basic features, the basic features including a center frequency and bandwidth of the detected signal,
undertake the ANN-based classification when initial classification using the basic features is unable to classify the detected signal, wherein the ANN-based classification comprises:
down-converting the detected signal to a baseband signal by a digital down-converter that uses direct digital synthesis;
filtering the baseband signal by a low pass filter to filter to form a low pass filtered signal;
extracting non-basic features of the signal from the low pass filtered signal; and
attempting the ANN-based classification using the non-basic features and trained weights.

17. The medium of claim 14, wherein the instructions further configure the cognitive radio to:
train the sensing policy during first and second training periods and train the communications policy during second training period but not the first training period, and
couple training of the sensing and communications policies during the second training period using the sensing and communications rewards.

18. The medium of claim 14, wherein:
the instructions further configure the cognitive radio to:
determine that the detected signal is significant enough to interfere with communication on the current communications channel,
generate a random number independent of whether the sensing policy indicates that the jammer is in the current communications channel,
randomly select a new communications channel when the random number is less than a communications exploration rate of random selection, and
when the random number is at least that of the communications exploration rate, select the new communications channel based on a communications channel likely to have a longest time without interference generated by the jammer as determined by the communications policy.

19. A method of implementing machine-learning in a cognitive radio to avoid a jammer, the method comprising:
detecting activity in a sub-band using a smoothed power spectral density estimator;
extracting a center frequency and bandwidth of each signal within the sub-band;
attempting to classify each signal as either a valid network signal or a jammer using the center frequency and bandwidth of the signal;
in response to failing to classify one of the signals using the center frequency and bandwidth of the one of the signals, attempting to classify the one of the signals using an artificial neural network (ANN)-based classification by using an ANN having input neurons of higher order cumulants of a sensing channel and an output neuron that provides the ANN-based classification of the one of the signals on the sensing channel, the ANN-based classification selected from the jammer and valid network signals;
training a sensing and communications policy to respectively track and avoid a jammer using multiple learning periods, and subsequently coupling the sensing and communications policy during communication using a current communications channel, the sensing and communications policy coupled by a sensing reward comprising a sensing weight times a sensing time and a communications reward comprising a communications weight times a communications time, the sensing time being a time the sensing policy has taken to determine presence of the jammer on a current sensing channel, and the communications time being a time the communications policy has allowed the cognitive radio to be jammed by the jammer, the sensing and communications weights being a negative value; and
avoiding communicating on the current communications channel when the jammer is present on the current communications channel in response to identifying a detected signal on the current communications channel as the jammer.

20. The method of claim 19, further comprising:
generating feedback over a control channel to another radio from which the cognitive radio is receiving a signal, wherein the feedback comprises identification of a new communications channel for communication with the cognitive radio, the control channel is different from the current sensing and communications channels, the feedback provided in response to the identifying of the detected signal on the current communications channel as the jammer, and
taking communications-based safeguards to protect the feedback against interference by the jammer.

21. The method of claim 19, further comprising:
generating a random number independent of whether the sensing policy indicates that the jammer is in the current communications channel,
randomly selecting a new communications channel when the random number is less than a communications exploration rate of random selection, and
when the random number is at least that of the communications exploration rate, selecting the new communications channel based on a communications channel likely to have a longest time without interference generated by the jammer as determined by the communications policy.
